(19) United States
(12) Patent Application Publication
(10) Pub. No.: US 2025/0022016 A1
(43) Pub. Date: Jan. 16, 2025

(54) SYSTEM FOR ARRANGING A USER INTERFACE TO A PLURALITY OF ORGANIZATIONS WITH A PLURALITY OF NEEDS

(71) Applicant: becauseOne, LLC, Franklin, IN (US)

(72) Inventors: Jon Raymond Winteregg, Franklin, IN (US); Stacia Jo Winteregg, Whiteland, IN (US); Nathan C. Reusser, Roanoke, IN (US); Austin M. Drummond, Roanoke, IN (US); Stefany N. Dolan, Franklin, IN (US); Jacob R. Smith, Roanoke, IN (US)

(21) Appl. No.: 18/722,484

(22) PCT Filed: Oct. 20, 2022
(86) PCT No.: PCT/US22/47310

§ 371 Date: Jun. 20, 2024

Related U.S. Application Data
(60) Provisional application No. 63/414,770, filed on Oct. 10, 2022.
(60) Provisional application No. 63/257,733, filed on Oct. 20, 2021.

(51) Int. Cl. G06Q 30/0279; G06F 9/451

(52) U.S. Cl. CPC G06Q 30/0279; G06F 9/451

(57) ABSTRACT

A method provides information regarding donations to organizations. The method includes obtaining in at least one server computer first affinity information selected by a first donor user, and obtaining in the at least one server computer second affinity information relating to each of a plurality of organizations. The method also includes determining in a computer processor of the at least one server computer a subset of the plurality of organizations based on a correlation of the first affinity information and the second affinity information. Graphic card information relating to the subset of organizations is provided to a first client computing device. The graphic card information is configured to be displayed on a user interface of the first client computing device such that a graphic card is displayed on the first client computing device identifying each of the subset of the plurality of organizations.

This application claims the benefit of U.S. Provisional Patent Application No. 63/414,770, filed Oct. 10, 2022, and U.S. Provisional Patent Application No. 63/257,733, filed Oct. 20, 2021, the disclosures of which are incorporated herein by reference in their entirety.

### FIELD OF THE INVENTION

The present invention relates to network computer systems that interact to provide interactions between donors and organizations receiving donations.

### BACKGROUND

Traditionally, non-profit organizations fulfill organizational needs using monetary donations. For example, if a non-profit community center requires office supplies, then the non-profit community center purchases office supplies from its available funds. The source of such funds is typically cash donations and/or government grants.

People contribute to non-profit organizations for various reasons. However, due to technological shortcomings, donating can generate little enthusiasm because, as practical matter, the donor provides money to the non-profit and then has little connection to how the donation fulfilled a need of the organization. The donor typically has little engagement with the organization, and the organization is limited in its ability to allocate resources to increasing such engagement.

In some cases, websites have been created to address this need by providing a way to explicitly identify needs of a non-profit (i.e. bicycles, wheel chairs, office supplies) and then allow the donor to direct funds to that need. However, the result only modestly increases the engagement of the donor to the organization.

What is needed is a system and/or method that facilitates engagement between donors and non-profit organizations.

### SUMMARY

At least some embodiments of the present invention offer a technical solution to the above-stated problem by creating a networked system and data structures that allow donors to match item donations (via online purchases, for example) with needs any one of a plurality of organizations, each organization having a room data object that illustrates the needs and facilitates transactions for donors to fulfill those needs, and which facilitates active engagement of other donors to the room data object.

A first embodiment includes method for providing a user interface to information regarding donations to organizations. The method includes obtaining in at least one server computer first affinity information selected by a first donor user, and obtaining in the at least one server computer second affinity information relating to each of a plurality of organizations. The second affinity information for each organization corresponds to an attribute of the organization. The method also includes determining in a computer processor of the at least one server computer a subset of the plurality of organizations based on a correlation of the first affinity information and the second affinity information. Graphic card information relating to the subset of organizations is provided to a first client computing device. The graphic card information is configured to be displayed on a user interface of the first client computing device such that a graphic card is displayed on the first client computing device identifying each of the subset of the plurality of organizations.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a block diagram of a computer system according to a first embodiment;

FIG. 2 shows a flow diagram of a set of operations of the server in interacting with the one or more client computing devices of the system of FIG. 1

FIG. 3 shows a block diagram set of data objects and linkages that form a database of the system of FIG. 1;

FIG. 4 shows an exemplary process carried out in conjunction with the server and client computing devices of the computer system of FIG. 1;

FIG. 5 shows an exemplary screen capture of a first display of a user interface generated by the system of FIG. 1;

FIG. 6 shows a first exemplary display a second display of the user interface generated by the system of FIG. 1;

FIG. 7 shows a second exemplary screen capture of the second display of FIG. 6;

FIG. 8 shows a third exemplary screen capture of the second display of FIG. 6;

FIG. 9 shows an exemplary screen capture of a third display of the user interface generated by the system of FIG. 1;

FIG. 10 shows an exemplary screen capture of a fourth display of the user interface generated by the system of FIG. 1;

FIG. 11 shows an exemplary screen capture of a fifth display of the user interface generated by the system of FIG. 1;

FIG. 12 shows an exemplary screen capture of a sixth display of the user interface generated by the system of FIG. 1; and

FIG. 13 shows a flow diagram of operations of the server of the system of FIG. 1 executed to generate email updates to users.

### DESCRIPTION

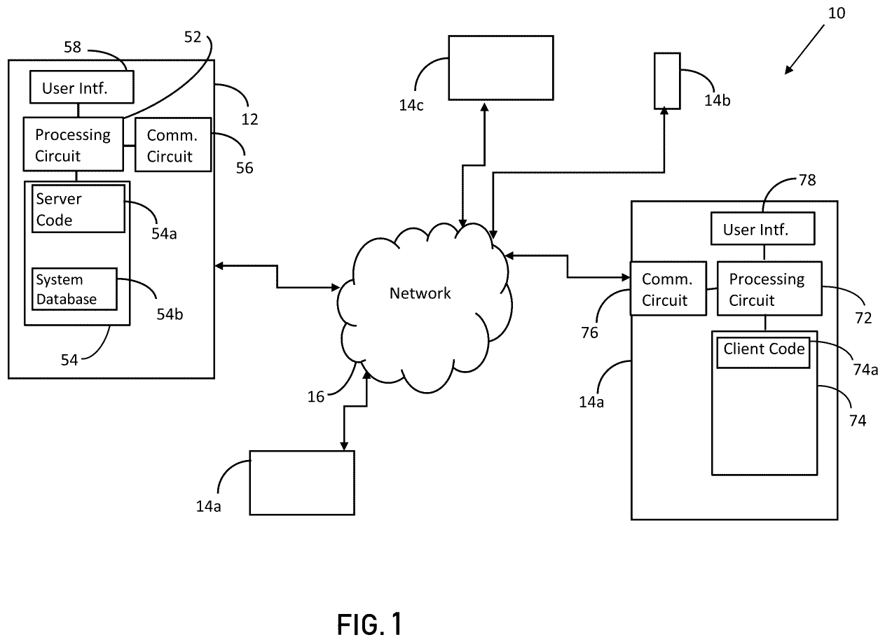

FIG. 1 shows a computer system 10 according to a first embodiment. The computer system 10 includes a server system (“server”) 12 and a plurality of client computing devices (“clients”) 14a, 14b, 14c, 14d, and so forth. The server 12 and the clients 14a, 14b, 14c, 14d, and so forth are connected via one or more networks 16, which may include the Internet.

In general, each of the server 12 and the clients 14 is a computing device or computing system that can take various forms of digital computers, such as laptop computers, desktop computers, platforms, personal digital assistants, servers, blade servers, mainframe computers, or other suitable computers. The server 12 can be a cloud server and/or a group of related services implemented across multiple server computers or similar devices. The server 12 can implement and/or comprise a serverless architecture, as is common in cloud computing. The server 12 can comprise a cloud computing server or a cloud host, which is a host product in the cloud computing service system to solve defects of difficult management and weak business scalability existing in traditional physical host and VPS (“Virtual Private Server”, or “VPS” for short) service. The operations of the one or more server computers that form the server 12 described herein are executed from a main software program stored in memory.

The client computing devices 14 can also be implemented as various forms of mobile devices, such as personal digital assistants, cellular phones, smart phones, wearable devices, and other similar computing devices. The components, their connections and relationships as well as their functions shown herein are merely examples, and are not intended to limit the implementation of the present application described and/or claimed herein.

As shown in FIG. 1, the server 12 includes a processing circuit 52, a memory 54, a communication circuit 56, and a user interface 58. The processing circuit 52, the memory 54, the communication circuit 56, and the user interface 58 are connected to each other via different buses, and can be mounted on a common mainboard, or mounted in another manner as required. As discussed above, the various elements of the server 12 may also be configured in a distributed architecture, such as in cloud processing.

In general, the processing circuit 52 processes instructions that are executed in the server 12, including instructions stored in or on the memory 54 to display graphical information via the user interface 58. In other embodiments, multiple processors and/or multiple buses may be used with multiple memories, if necessary. Similarly, multiple electronic devices can be connected, each providing some necessary operations (for example, serving as a server array, a group of blade servers, or a multi-processor system). One processor 52 is shown as an example in FIG. 1.

The memory 54 is a non-transitory computer-readable storage medium provided by the present application. The memory 54 has stored thereon instructions or server code 54a that are executable by the processor 52 so that the at least one processor 52 executes the operations attributed to the server 12 discussed herein, for example, to execute a method for providing a user interface to information regarding donations to organizations. The server code 54a may include code for generating webpages that make function calls to distributed services that carry out the operations ascribed to the server 12 below.

As a non-transitory computer-readable storage medium, the memory 54 can be used to store non-transitory software programs, non-transitory computer executable programs, and modules, such as program instructions/modules corresponding to the method for providing a user interface to information regarding donations to organizations. The processor 52 executes various functional applications of the server and data processing by running the non-transient software programs, instructions and modules stored in the memory 54.

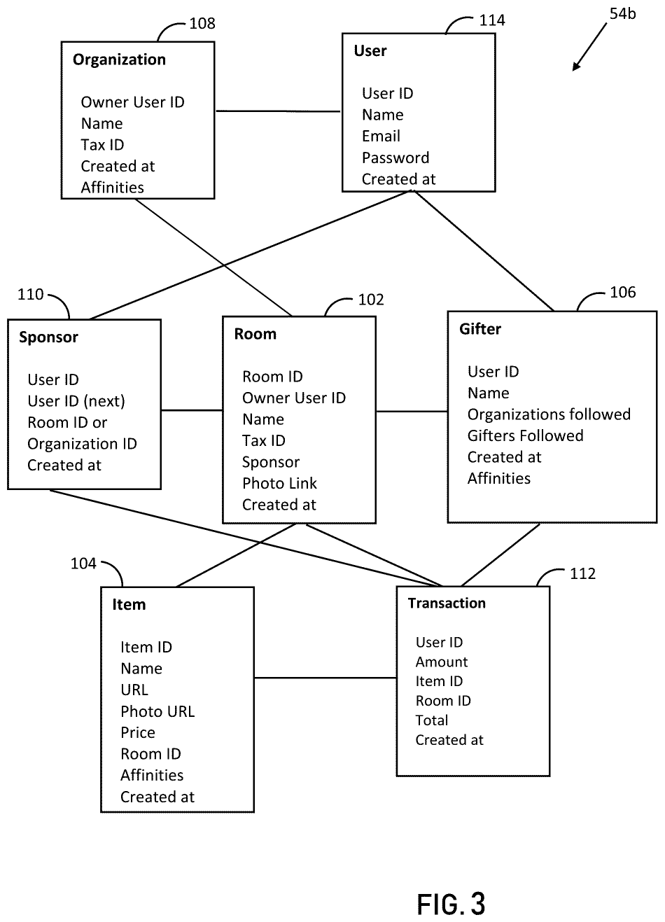

The memory 54 can include a program storage area 54a, which stores an operating system and an application required by at least one function, and a data storage area 54b, which stores the system database including the data objects as discussed herein, such as those shown in FIG. 3. The memory 54 may include a high-speed random access memory, and may also include a non-transitory memory, such as at least one magnetic disk storage device, flash memory devices, or other non-transitory solid-state storage devices. In some embodiments, the memory 54 may optionally include storage that is remotely located from the processor 52, but connected thereto via a network and other processing devices. Examples of the aforementioned network include, but are not limited to, internets, corporate intranets, local area networks, mobile communication networks, and combinations thereof. The user interface 58 can include user input devices and output devices. The communication circuit 56 is a communication device capable of communicating through one or more networks 16 to the various clients 14a, 14b, 14c and 14d, as well as other computers. The communication circuit 56 can be configured for any form or medium of digital data communication (e.g., a communication network). Examples of communication networks include a local area network (“LAN”), a wide area network (“WAN”), and the Internet.

As discussed above, the clients 14 can be implemented as various forms, such as desktop computer or mobile devices, such as personal digital assistants, cellular phones, smart phones, wearable devices, and other similar computing devices. The components, their connections and relationships as well as their functions shown herein are merely examples, and are not intended to limit the implementation of the present application described and/or claimed herein.

As shown in FIG. 1, the client 14a includes a processing circuit 72, a memory 74, a communication circuit 76, and a user interface 78. The processing circuit 72, the memory 74, the communication circuit 76, and the user interface 78 are connected to each other via different buses, and can be mounted on a common mainboard, or mounted in another manner as required.

In general, the processing circuit 72 processes instructions that are executed in the client computing device 14a, including instructions stored in or on the memory 74 to display graphical information via the user interface 78. In other embodiments, multiple processors and/or multiple buses may be used with multiple memories, if necessary. One processor 72 is shown as an example in FIG. 1.

The memory 74 is a non-transitory computer-readable storage medium provided by the present application. The memory 74 has stored thereon instructions or client code 74a that are executable by the processing circuit 72, including by way of example a web browser, so that the at least one processor executes the operations attributed to the server 14a discussed herein, for example, to assist in implementing the method for providing a user interface to information regarding donations to organizations.

As a non-transitory computer-readable storage medium, the memory 74 can be used to store non-transitory software programs, non-transitory computer executable programs, and modules, such as program instructions/modules corresponding to the method for providing a user interface to information regarding donations to organizations. The processor 72 executes various functional applications of the server and data processing by running the non-transient software programs, instructions and modules stored in the memory 74.

The memory 74 includes a program storage area containing the client code 74a, which stores an operating system and the server program(s) that carry out the operations discussed herein attributed to the server 12. The memory 74 also stores data regarding the various operations of the system 10 as discussed below. The memory 74 may include a high-speed random access memory, and may also include a non-transitory memory, such as at least one magnetic disk storage device, flash memory devices, or other non-transitory solid-state storage devices. In some embodiments, the memory 74 may optionally include storage that is remotely located from the processor 72, but connected thereto via a network and other processing devices. Examples of the aforementioned network include, but are not limited to, internets, corporate intranets, local area networks, mobile communication networks, and combinations thereof.

The communication circuit 76 is a communication device capable of communicating through one or more networks 16 to the server 12, as well as to other computers. The communication circuit 76 can be configured for any form or medium of digital data communication (e.g., a communication network). Examples of communication networks include a local area network (“LAN”), a wide area network (“WAN”), and the Internet.

The user interface 78 can include one or more user input devices and one or more output devices. The input device can receive input digital or character information, and provide a way for a human user to provide input to the processor 72. The input device can include, for example, a touch screen, a keypad, a mouse, a trackpad, a touchpad, a pointing stick, one or more mouse buttons, a trackball or a joystick. The output device of the user interface 78 is configured to provide output from the processor 72 in human perceptible form, and may include a display device, an auxiliary lighting device such as a light-emitting diode (LED), and a tactile feedback device such as a vibration motor. The display device may include, but is not limited to, a liquid crystal display (LCD), a light-emitting diode (LED) display, and a plasma display. In some embodiments, the display device may be a touch screen.

Although other client computing devices 14b, 14c and 14d may take different forms, they all have the same general structure (processor, memory, user interface, and communication circuit) as the client 14a.

It will be appreciated that various implementations of the systems and techniques described herein can be implemented in a digital electronic circuit system, an integrated circuit system, an application specific integrated circuit (ASIC), computer hardware, firmware, software, and/or a combination thereof. These various implementations may include implementation in one or more computer programs, which may be executed and/or interpreted on a programmable system including at least one programmable processor. The programmable processor can be a dedicated or general-purpose programmable processor that can receive data and instructions from, and transmit data and instructions to, a storage system, at least one input device, and at least one output device.

In one aspect of the system 10, the system 10 provides a user interface that efficiently organizes and presents information regarding needs of organizations to potential donors. To this end, the client computing devices 14a, 14b, 14c and 14d may be client computing devices of donor users or organization having needs for items (including services). In general, the server 12 maintains the database 54b, which includes identification information regarding a plurality of donor users (“Gifters”), a plurality of organizations (“Organizations”), and a plurality of items needed by the plurality of organizations (“Needs”). The server 12 generally obtains the Gifter information, Organization information, and Needs information from system users (Gifters and Organizations) via the plurality of client computing devices 14a, 14b, 14c and 14d. As will be discussed below, the server 12 is configured to carry out a method to present select Needs of the Organizations to the Gifters via one of more the plurality of client computing devices 14a, 14b, 14c and 14d, and carry out donation transactions relating to the needs, among other things.

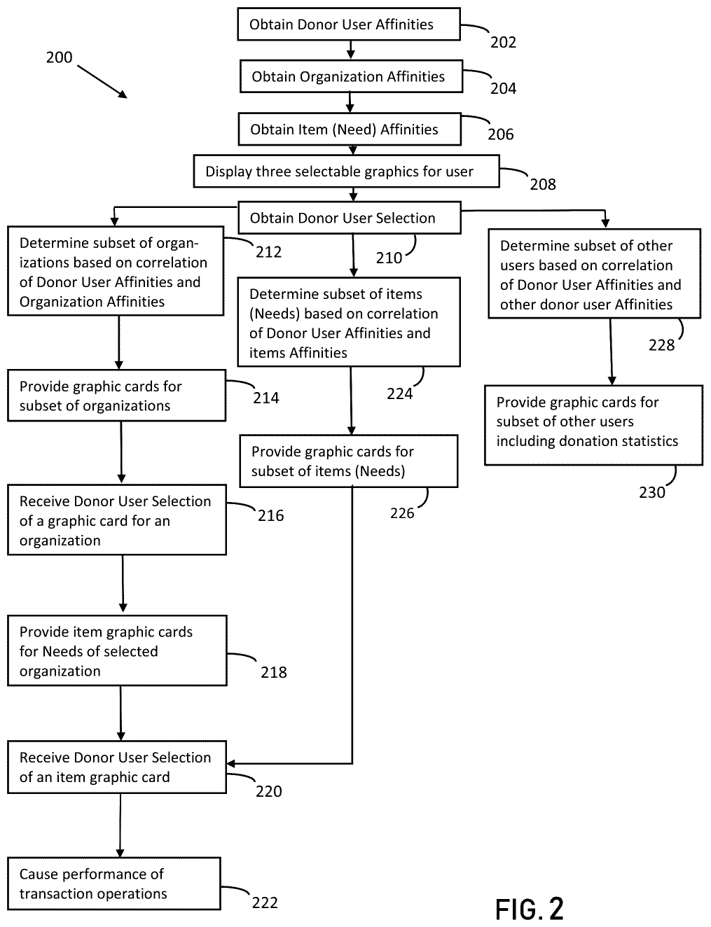

FIG. 2 shows a flow diagram 200 of a set of operations of the server 12 in interacting with the one or more client computing devices 14a, 14b, 14c, and 14d to provide user interface that efficiently organizes and presents information regarding needs of organizations to potential donors.

In step 202, the server 12 obtains first affinity information selected by a first donor user or Gifter. In this embodiment an affinity may relate to a passion or interest of the Gifter, and is preferably selected from a predetermined list of affinities. The predetermined set of affinities can include, by way of example, the affinities shown in Table 1. However, the variants of lists of affinities that may be used are numerous.

TABLE 1

Animals
Arts/Culture & Humanities
Children & Youth
Community Improvement
Crime & Justice
Education
Entertainment & Leisure
Environment
Food, Agricultures & Nutrition
Health & Wellness
Healthcare
Housing & Shelter
International Affairs
Medical Research
Mental Health & Crisis Intervention
Public Safety & Disaster Relief
Religion
Science & Technology
Social Rights/Action & Advocacy
Sports & Recreation
Veterans & First Responders

To obtain the first affinity information for a first user, the server 12 may suitably send a web page to a client computer, e.g. client 14a. The client 14a renders the web page to provide a display screen having selectable elements, such as buttons, for each of the list of affinities. The client 14a accepts the user selections of the buttons corresponding to selected affinities, and transmits selections using conventional means to convey the user selections to the server 12 with the identity of the selected affinity. The server 12 may perform step 202 for a plurality of donor users or Gifters at a plurality of client computers 14.

In step 204, the server 12 obtains second affinity information relating to each of a plurality of organizations in the database, wherein the second affinity information for each organization corresponds to an attribute of the organization. For each organization, which may suitably be a charitable organization or other not-for-profit entity, the attribute may be related to the mission statement of the organization, the stated purpose of the organization, or items or systems which the work of the organization otherwise impacts. The second affinity information preferably is selected from the predetermined set of affinities, such as for example, those of Table 1.

To obtain the second affinity information for each organization, the server 12 may suitably send a web page to a client computing device 14b operated on behalf of the organization. The client computing device 14b renders a display screen having selectable elements such as buttons for each of the list of affinities. The client computing device 14b accepts the user selections of the buttons corresponding to selected affinities, and transmits selections using conventional means to convey the user selections to the server 12 with the identity of the selected affinity. The server 12 performs step 204 for a plurality of organizations associated with a plurality of client computers 14.

In step 206, the server 12 obtains third affinity information relating to each of a plurality each of a plurality of items or Needs, the items corresponding to donation needs of the plurality of organizations. In particular, the server 12 stores in the database 54b information identifying items that have been identified by the organization as items of need for organization. For example, a local Boys and Girls Club may need basketballs, and a local Humane Society may need paint, as well as specialized dog food. Each organization of the plurality of organizations in the system has one or more Needs.

To obtain the third affinity information for each organization, the server 12 may suitably send a need soliciting web form or web page to a client computing device 14b operated on behalf of the organization. In one embodiment, the client computing device 14b renders a display screen having a text-fillable elements that can be used to identify the Need by common terms, such as “bicycle”, “basketball” etc. The client computing device 14b also provides on the same display or a subsequent display buttons or other selectable graphic elements for each of the predetermined set of affinities. The affinities associated with an individual Need may be different than the affinities associated with the Organization that has the Need. For example, the Human Society may have an affinity listed as “Animals”, but may have a Need for a laptop computer, which may have an affinity listed as “Science and Technology”. The client computing device 14b accepts the Needs information and user selections of the buttons corresponding to selected affinities, and transmits corresponding information using conventional means to convey the user selections to the server 12. The server 12 performs step 206 for a plurality of organizations associated with a plurality of client computers 14.

The steps of the flow chart 200 disclosed below typically can occur for any donor user or Gifter in a normal server/client session. An example of a user session between the server 12 and a first donor user or Gifter using the client 14a is discussed below.

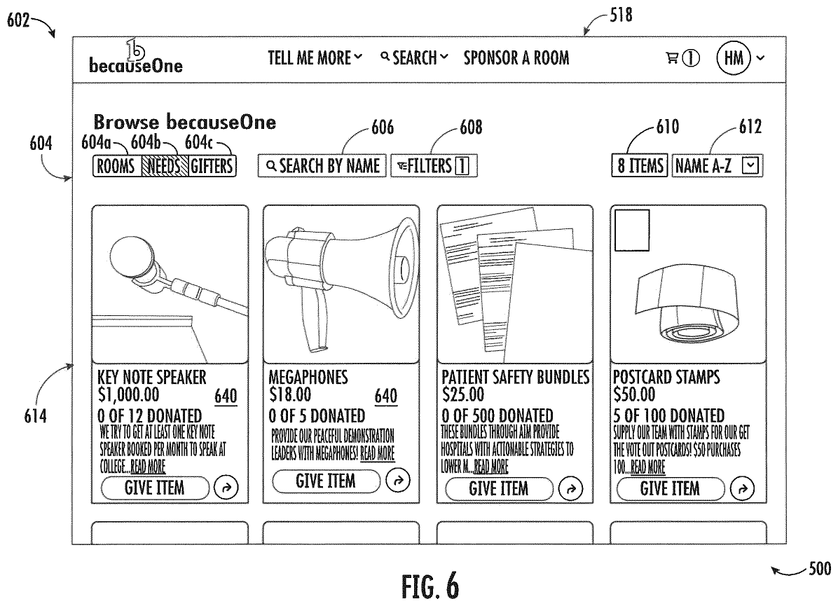

In accordance with one aspect of the method, the server 12 in step 208 provides user interface information to the client computer 14a of the first donor user that causes the client 14a to present graphical user interface display including first, second and third selectable graphics. By way of example, FIG. 6, shown further below, shows a browser display 602 which includes a selectable Rooms button 604a, a selectable Needs button 604b, and a selectable Gifters button 604c.

When the client 14a receives via user interface 78 a selection of one of the buttons, the client 14a conveys information identifying the selection to the server 12. In step 210. the server 12 receives the selection information. If the first button was selected, then the server 12 proceeds to step 212. If the second button was selected, then the server 12 proceeds to step 224. If the third button was selected, then the server 12 proceeds to step 228.

In step 212, the server 12 determines a subset of the plurality of organizations stored in the database based on a correlation of the first affinity information and the second affinity information. By way of example, the server 12 may add to the subset of the plurality of organizations any Organization having an affinity (in its second affinity information) that matches one of the affinities of the first donor user (first affinity information).

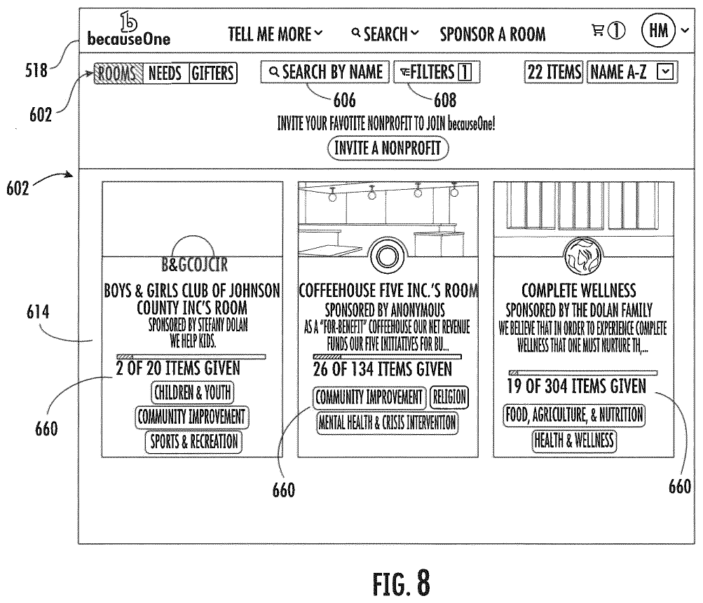

In step 214, the server 12 provides graphic card information relating to the subset of organizations to the first client computer 14a. The graphic card information is configured to be displayed on a user interface of the client 14a such that a graphic card is displayed on the client 14a identifying each of the subset of the plurality of organizations. FIG. 8, discussed further below, shows an exemplary display 602 showing a plurality of graphic cards 660 that may be generated in step 214, wherein each card 660 is associated with an Organization.

The graphic card information is configured such that each graphic card includes a first link selectable via the user interface 78 of the client 14a. The first link is associated with the organization identified in the graphic card. If the client computer device 14a receives a user selection of the first link in a graphic card associated with a particular organization, the server 12 receives from the client 14a the Organization card selection in step 216.

Upon receives the Organization card selection in step 216, the server proceeds to step 218. In step 218, the server 12 provides further graphic card information, wherein the further graphic card information is configured to be displayed on a user interface of the client computing device such that further graphic cards are displayed. Each of the further graphic cards is a Need graphics card that identifies one of the items or Needs of the Organization selected by the user after step 214. At least some of the further graphic cards preferably identify a cost per item, a quantity of items needed, and a further link to a transaction operation.

If the client 14a receives input indicating the donor user has selected the link to the transaction operation (i.e. a purchase option) on one of the item cards, then the server 12 in step 220 receives information identifying that the item card has been selected for a transaction. The server 12 then in step 222 then causes a set of transaction (including payment) operations to take place whereby the first user can, using ecommerce methods, provide payment corresponding to the cost of one or more of the items associated with the selected item card.

As discussed above, the server 12 executes step 224 if the second button is selected in step 210. In step 224, the server 12 determines a subset of the plurality of items or Needs stored in the database based on a correlation of the first affinity information and the third affinity information. By way of example, the server 12 may add to the subset of the plurality of items any item or Need having an affinity (in its third affinity information) that matches one of the affinities of the first donor user (first affinity information).

In step 226, the server 12 provides graphic card information relating to the subset of items to the client 14a. The graphic card information is configured to be displayed on a user interface of the client 14a such that a graphic card is displayed on the client 14a identifying each of the subset of the plurality of items. FIG. 6 discussed further below, shows an exemplary display 602 showing a plurality of graphic cards 640 that may be generated in step 226, wherein each card is in the subset of needs that has been correlated to the first user via at least one matching affinity. Each graphic card has the same structure as the graphic cards generated in step 218, and thus identifies a cost per item, a quantity of items needed, and a further link to a transaction operation.

If the user selects the link to the transaction operation (i.e. a purchase option), then the server 12 proceeds to step 220, discussed above, and proceeds accordingly. Thus, the first user can conduct a transaction from the client 14a corresponding to a need either by selecting from items associated with organizations that have at least one matching affinity, or by selecting from items themselves having at least one matching affinity.

As discussed above, the server 12 executes step 228 if the third button is selected in step 210. In step 228, the server 12 determines a subset of the plurality of other donor user (or Gifters) stored in the database based on a correlation of their first affinity information and the first affinity information of the first user. By way of example, the server 12 may add to the subset of the plurality of other users any donor user having an affinity (in its first affinity information) that matches one of the affinities of the first donor user (first affinity information).

In step 230, the server 12 provides graphic card information relating to the subset of other donor users to the client 14a. The graphic card information is configured to be displayed on a user interface of the client 14a such that a graphic card is displayed on the client 14a identifying each of the subset of the plurality of other donor users, and donation statistics corresponding to the donor user identification information. Thus, the system 10 provides an interactive way to obtain information regarding users with similar interests, as well as information relating to their donation or transaction history.

FIG. 3 shows a diagram of the organizational structure of the database 54b maintained and used by the server 12. The organizational structure provides an improved technical solution for presenting a graphical user interface that efficiently presents gifting options and statistics regarding gifting involving payors and payees. The data objects discussed below may be organized as comma separated data files or a combination of data files and data tables. At least some of the data in the data objects may be organized into pivot tables normally used in relational databases. Thus, some of the data points in the data objects disclosed below are organized via cross-references to pivot tables not specifically shown on FIG. 3.

The server 12 maintains at least one room data object 102 for each organization user (i.e. the users that receive payments or donations). As discussed above, each data object may be a comma separated file, or a combination of a comma separated file and entries in pivot tables or other tables that reference the ID of the data object or comma separated file.

Each room data object 102 is linked to a plurality of item data objects 104, gifter data objects 106, at least one organization data object 108, a sponsor data object 110, and transaction data objects 112. Each room object includes data representative of a Room ID, an Organization ID, a Room Name, a Sponsor ID, among other things. The Room ID is the identification of each room object 102 within the system 10. Each room ID identifies the data associated with a particular organization's virtual “room”.

The Organization ID is the organization associated with the Room ID. The Room Name may be a textual familiar name (for example, selected by the organization or sponsor), as opposed to a structure ID string. Each of the Sponsor IDs is the User ID of a user that has become a sponsor of the room, as will be discussed below. As discussed above, each organization includes one or more Affinities. These Affinities may suitably be associate with the Room ID or Organization ID via a pivot table. Several of the data blocks includes a “created at” entry or field which indicates the date that data block was created. The server 12 stores the “created at” block when the data block is created so that the server 12 can provide users with news items and email updates relating to the most recently created rooms, sponsorships, Needs, and updates relating to most recent donations.

The item data objects 104 include information for items that can represent needs of a charitable organization, and includes an item name, an estimated price. Items can include goods and services. The item data objects 104 each include a Room ID identifying the Room ID with which the item data object 104 is associated. The item data objects 104 further include Affinities as discussed above. The item affinities may also be stored via a pivot table in a relational database. The affinity can be one (or more) of a set of predetermined affinities to which the item relates, which can be independent of the affinities of the Organization.

Each gifter data object 106 is associated with a user object 114. The user object 114 includes the User ID, credentials and contact information for a user of the system, such the first donor user that uses the computing device 14a. The corresponding gifter data object 106 includes the User ID, a Gifter Name, a list of Organizations followed, a list of favorited items, a list of Gifters followed, a list of Rooms following, among other things. The User ID is the User ID of the corresponding user object 114. The Gifter Name is a screen name associated with the Gifter that can be different than the User Name associated with the User ID. Having a separate data object and name for Users and Gifters allows the Gifter to be anonymous, or otherwise different from the user for privacy or other reasons. The list of Organizations followed is a list of Organization Names that the gifter/user has selected to follow. The list of Favorited items includes Item Names that are user-selected as favorites. The list of Gifters followed is a list of Gifter Names that the user/gifter has selected to follow. The list of Rooms followed is a list of Room Names or Room IDs followed.

The gifter data object 106 also includes an affinities field that contains data identifying affinities (selection filter information) of the user. As discussed further below, the selection filter information or affinities identifies things in which the user is interested, is passionate above, and/or is concerned about. In this embodiment, the affinities are selected from a predetermined set of possible affinities by the gifter when the gifter registers on the system 10. The gifter may also edit the list of affinities at later times.

An exemplary set of affinities is set forth above in table 1. However, it will be appreciated that the list of predetermined affinities may vary. In still other embodiments, the list of affinities may simply include “freeform” text data entered by the user instead of selections from a predetermined set of affinities.

The gifter data object 106 also in some embodiments includes a number of Gifts Donated, a list of Followers, and a number of Rooms Sponsored. The number of gifts donated tracks the number of transactions associated with the User Id accumulated over time. In some embodiments, the Gifts Donated can include a list of the Transaction data object 112 for which the User Id was associated. In some embodiments, the gifter data object 106 does not track the numbers of gifts donated, but rather is derivable from the Transaction data object 112. The list of Followers contains the Name for each User Id (or just the User Id) associated with each other Gifter whose gifter data object 106 has the gifter in its Gifters Followed field. The list of

Followers need not be in a comma separated file, but may also be in a pivot table that tracks User IDs following other User IDs. The Rooms Sponsored contains a list of each Room ID for which the Room Object 102 lists the gifter as a sponsor. It will be appreciated that some of these fields may be redundant, and that the same information may be obtained in real time by searching the appropriate fields in other data objects 102, 106, and 112.

Each Sponsor data object 110 is also associated with a user data object 114, and thus contains the corresponding User ID. As a result, each credentialed user having a User ID and user block 114 can be a gifter and/or a sponsor.

Each Organization data object 108 is associated with an organization, such as non-profit organizations, that are organization users of the system 10. Each Organization data object 108 includes an Owner User ID, an Organization Name, a Tax ID, an Identifier, a list of affinities, among other things. The list of affinities contains a set of potential gifter affinities to which the organization is relevant, and/or which is otherwise associated with the goals and impact of the organization. In this embodiment, the list of affinities is selected from the predetermined set of affinities discussed above. Thus, for example, if organization A is a food bank, then its Interest field may include “Food, Agricultures & Nutrition”, “Children & Youth”, and “Community Improvement”. The data in the Interest field of each Organization data object 108 may be generated by the organization when it registers, and/or can be edited. The software (i.e. server 12) may contain controls to prohibit any organization from trying to list all (or most) affinities to obtain the greatest number of matches with potential gifters. For example, the server 12 may limit each Organization data object 108 to no more than a predetermined number of affinities, such as for example, two affinities. The server 12 may include provision for the organization to identify a “primary” affinity and one or more secondary affinities, which would represented accordingly in the Organization data object 108.

Each Transaction data object 112 contains the data surrounding a giving transaction, for example, an object purchased by a Gifter for a Room of an Organization. In one embodiment, the donation of an Item in a giving transaction involves a donation from the Gifter to the Organization for an amount associated with the Item, and an indication that it is allocated to a particular Item. Each Transaction data object 112 includes the User ID of the Gifter, the Amount or quantity of Items donated, Item Name, Room ID, a Total (value of the donation), among other things.

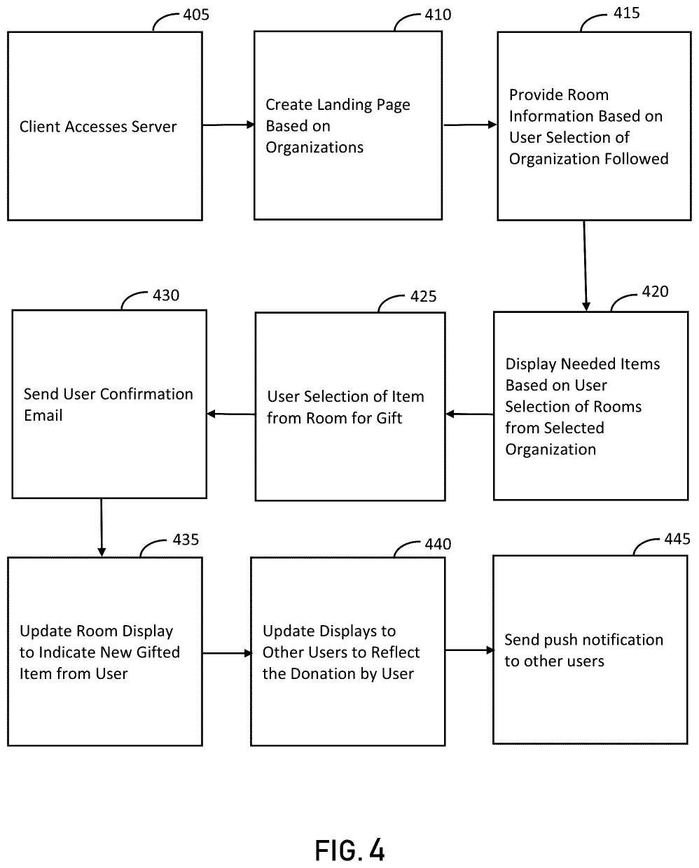

FIG. 4 shows a flow diagram of the exemplary operations of an embodiment of the system 10 in which the operations of FIG. 2 may be carried out. The operations of FIG. 4 will be described in an exemplary scenario wherein a first user referenced as User 1 accesses the system via client 14a. However, it will be appreciated that multiple other users at any of the client computing devices 14a, 14b, 14c, 14d and so forth using the same overall process. The operations of FIG. 4 take place after User 1 has registered with the system 10 and has a corresponding user data object 114 and gifter data object 104, including User 1′s User ID.

In step 405, User 1 accesses the server 12 via the computing device 14a and the network 16. This may be done through an application downloaded to the user computing device 14a or via a client or plug-in 15 in a web browser on the computing device 14a. Herebelow, the description will refer to operations of the server 12 to include providing information to the downloaded application on the computing device 14a that interfaces with User 1. The user goes through a credentialing process and is verified to be an authorized user having a User ID using the credentialing information in the user data object 114 associated with the User ID.

Once the session with the user is initiated, in step 410, the server 12 causes a landing page to be generated for the User at least in part based on the Organizations Followed and Gifters Followed list via the gifter data object 106 associated with the User ID. In some cases the server 12 can use obtain the Organizations Followed by searching a corresponding pivot table for entries with the User ID. The platform 12 causes the computing device 14a to display the list of Organizations Followed and/or Gifters followed, or updates based on recent Transactions associated with the User IDs of Gifters followed and/or Organizations Followed.

The user can select an organization from the displayed list at the computing device 14a (via suitable GUI techniques). The selection is communicated to the server 12. In response, the server 12, in step 415, first identifies all Room Id's associated with the Organization. For example, if the user selects Organization A, the server 12 identifies all Room Id's having room data objects 102 in which the Organization ID corresponds to organization A. The server 12 further retrieves all items recently received corresponding to each Room Id. The server 12 then causes the list of Room Names corresponding to the identified Room Id's, and the recently received items corresponding to the identified Room Id's to be displayed at the computer 12. In one embodiment discussed further below, each organization is associated with a single room, and thus the Room ID is associated automatically with the Organization ID.

The user can then select a room to display (or more, using multiple windows). The Room Id selection is communicated to the server 12. In response, the platform in step 420 causes to be displayed at the user computer 12 information identifying needed items, already gifted items, and any cash goals and/or gifted totals associated with the Room Id. The Room Name, Room Sponsor and recent gifters may also be displayed.

To display needed item information, the server 12 in step 420 identifies all of the item data objects 104 having a Room Id value that matches or otherwise corresponds to the Room Id of the user selected room. For each identified item data objects, the server 12 obtains the URL and/or photo URL and causes a link to the URL to be displayed at the user computer 12. The URL and/or photo URL is the URL of a purchase page for the item in question, for example, from an on-line vendor. The URL may alternatively be a link to a cash transaction or donation server.

Thereafter, the user in step 425 selects an item to gift by selecting the corresponding link on the user computer 12. The user (i.e. gifter) then donates the amount of money to purchase the item for the room. To this end, a transaction data object 112 is created, and populated with the User Id, the Item Id, the Room Id, and the Amount of the purchase. The Server 12 notifies the Organization that the item has been gifted and forwards an appropriate amount, preferably electronically, to the organization.

After the transaction is completed, the server 12 in step 430 causes a confirmation email to be sent to the user computer 12. A new transaction data object 112 (see FIG. 3) is also created. In step 435, the server 12 then causes the room display associated with the Room Id to be updated with the newly gifted item shown under the recently gifted category. The server 12 then sends communication (e.g. email or text) to a contact point for the receiving Organization notifying that the Organization that the Item has been purchased.

The server 12 thereafter in step 440 updates the web interface for followers of the gifter and followers of the organization. Thus, for other gifter data objects 106 that have a Gifter Followed value (identifier) that matches the gifter of the transaction the server 12 updates the other gifter's web interface (in the other gifter's sessions) to show that the Item has been gifted by the gifter. Similarly, the server 12 identifies other gifter data objects 106 that have an Organizations Followed value (identifier) that matches the Organization Id value of the room of the transaction of step 425. The server 12 updates such other gifter's web interface to show that the Item has been gifted by the gifter.

It will be appreciated that the update may occur through the server 12 identifying new transaction data objects 112 having the Owner User ID (via the Room ID of the transaction data object 112) that correspond to the Organizations Followed for other users. The update can also occur by the server 12 identifying new transaction data objects 112 having the User ID that corresponds to the Gifters Followed for other users.

In step 445, the server 12 causes a push notification to be sent to qualifying users regarding the transaction of step 425, for example, by email message or other pushed social media notification. Thus, for other gifter data objects 106 that have a Gifter Followed value (identifier) that matches the gifter of the transaction, the server 12 sends a push notification using the email of User ID associated with each identified other gifter data object 106. Similarly, for each other gifter data objects 106 that have an Organizations Followed value (identifier) that matches the Organization Id value of the room of the transaction of step 425, the server 12 sends a push notification using the email of User ID associated with each identified other gifter data object 106.

### System Architecture

In some embodiments, Amazon Web Services host and support the application from all sides. AWS offers a variety of services which allows applications that scale as the business scales. The system 10 uses a server 12 having a serverless architecture, combining S3, CloudFront, Lambda, API Gateway, DynamoDB, and ElasticSearch for Web Services. The system 10 uses native languages for each mobile platform, which are Swift and Kotlin.

### Web Application

The web application (i.e. on the computing device 14a, etc.) serves multiple purposes, dependent upon the user's purpose for the platform. The system 10 serves two distinct functions: to give and to receive. The server 12 includes an application which allows Organization users (NPOs) to set up rooms of items needed. The system 10 offers an easy way to match Gifters with the NPOs they are interested in helping. In this embodiment, the same Web Application is available for both Organizations and Gifters. NPOs are able to create rooms, and fill those rooms with items. Gifters are be able to find NPOs, and donate to them in a variety of ways.

### User Registration

Regardless of the user's purpose on the site, the user needs a user account. One user account (user data block 114) is used for all the distinct purposes. When an account is created, it is tied to an individual. Users can setup Two Factor Authentication via TOTP/Google Authenticator. The system 10 in some cases may offer Two Step Verification through SMS. After completing the full process, users are greeted with an onboarding process custom tailored to their main account type to familiarize themselves with the platform.

### Not For Profit Registration

After creating an account, a user who chooses to proceed with claiming a Not For Profit can search for their NPO via the IRS.gov database. The server 12 can search and find all Not For Profits listed and allow users to claim their Not For Profit. To claim their NPO, the user must give the system 10 a couple pieces of information, including the Tax ID associated with the NPO. This allows the system 10 to validate this user's permission to represent this organization. More information can be used or requested in order to confirm or validate the user, should there be issues with using the Tax ID verification process. The NPO also provides the system 10 which affinities their NPO should be associated with. This allows matching Gifters with these affinities. The system 12 allows the NPO to be claimed by users via Tax ID, with backup verification methods implemented. The NPO can alternatively be claimed through a manual process, which includes contacting the organization via its registered contact information, separately from the user's provided contact information, in order to prevent unauthorized claiming. Upon registration, the NPOs provide their location so that the server can match them with gifters based on geographical criteria.

### Not For Profit Profile

The Not For Profit is able to add additional information to customize their organization's profile. This profile is seen by users on the platform. NPO registration includes filling out physical address, phone number, website address, logo, social profile URLs, and background photo. NPOs also may customize their purposes in later access in the event they skipped or want to change their purpose from the NPO Registration.

### Not For Profit Rooms

NPOs main intent on the platform is to create “Rooms”, each associated with a room data object 102 and an organization user data object 108. Room data objects 102 contain or reference the NPOs needs in the form of item data objects 104. Rooms in this embodiment have an annual cost in order to accept donations for specific items. Every room has its own information associated with it, including the room data object 102 as discussed above, but which can include a description, photo, sponsorship, room status (pending, active, archived), payment information (if not sponsored), room open date, bank information (required for claiming gifts)

NPOs are able to create one or more rooms. NPOs are required to fill out the room's basic information profile, as well as adding a photo to personalize their room. The server also stores a status of the room, which may be associated with the Room ID. The possible statuses include: Pending (Not yet live due to date, payment or other reasons), Active, or Archived (Ended by the NPO, date, room needs fulfilled, etc.) When setting up and paying for a room, the server 12 makes an option to automatically renew their room annually available. Bank information is required when claiming donations. NPOs can add Needs to Rooms, without a room being fully funded.

### Not For Profit Room Needs

After creating a room, the server 12 prompts organization users to start adding needs to their rooms. Needs, or items, are added manually through a form. The form, which is presented by the server 12 to a corresponding user computer 14a, 14b, 14c or 14d, includes basic fields such as title, quantity, price (all costs, including tax and shipping), description, photo and URL. When pasting the URL, some information is automatically be fetched in order to expedite the form process. If the URL does not contain an OpenGraph photo, the system 10 makes royalty-free photos available to be used. The need also has a type: Good, Services or Cash. All needs can be partially gifted by any number of users. NPOs are able to manually order the default appearance of needs in the room. This order is called the Priority sort.

### Not For Profit Room Widget

After creating a room, (NPO) users are given an embed code snippet they may place on the organization website, such as a website hosted on another server, not shown, but which may be user computer 14a, 14b, 14c or 14d. This allows the NPO to display this room on their website, offering a way for their visitors to discover their room on the system 10. This increases the visibility of the server 10, without requiring their donors to leave the NPO website to view and browse their needs. This improves the overall presence of the platform, as well as extending its reach.

To this end, in some embodiments, every room has an embed widget for NPOs to include on their website, which causes display of the NPO Room's needs on the NPO website. The widget therefore includes some or all of the data in the item data objects 104 associated with the Room ID of the NPO. The widget further enables users to finish their donation on the system 10.

### Not For Profit Donation Transactions

Once a gifter has completed their donation within the system 10, the server 12 causes a series of events occur. Every transaction has a percentage fee associated with it, which see those funds settle in a separate bank account than the full donation amount to cover the cost of the needs donated to the NPO. Once the funds have settled, a notification is sent to both the gifter and the NPO. The NPO is then be able to claim the donation and have the amount sent straight to their bank account. The server 12 also notifies the NPO as to the need which was donated and the associated URL. Once the item is purchased the need, the NPO is able to mark the need as purchased and optionally provide an update message and/or photo to be sent to the gifter and/or the NPO's profile. All needs display a progress bar that indicates how many units of that need remain in order to fulfill the NPO's requirement. Once a need has been completely fulfilled, the need is greyed out, but still remains visible in the room, but only appearing after unfulfilled needs.

In some cases, Donations are claimed via Stripe Connect or a similar service. Additionally, Needs have a displayed progress bar or other progress information to indicate their donation status. Fulfilled needs appear after unfulfilled needs by default. NPOs can optionally track offline donations to highlight donations which occurred outside the system 10.

### Not For Profit Reporting

NPOs are able to access a handful of reports to allow them access to a large amount of information as an export, or as a summary. Reports include a Year-End Donation Summary, Gifter report, and Room Performance.

### Not For Profit Dashboard

NPOs are greeted with their dashboard (e.g. on the GUI 78 of one of the user computing devices 14a, 14b, 14c etc.) after logging on or creating their account. The dashboard is the gateway to most interactions they would typically need, such as managing rooms, viewing recent donations and gifters, and managing account settings. There is also a place to view Tips and Suggestions offered by the server 12. The dashboard also provides key metrics, such as total amount received, total number of gifters, percentage completion of all rooms, or any other key metrics deemed important. The dashboard also displays any notifications or alerts NPOs need to be aware of. All of such information is obtained from the database 54b.

### Gifter Registration

After creating an account, a user who chooses to proceed with being a gifter fills out basic information, such as their name, birth date, location, profile picture, bio, and social links. The user is also prompted for their affinities, such as described connection with step 202 of FIG. 2. This helps match them with NPOs with corresponding purposes or impacts. Gifters are prompted for their payment information, but are allowed to defer this until they actually complete a donation. Gifters are also asked if they represent a Corporation, who may be giving donations or Sponsoring a room. These Corporations are manually verified by system operators. The user representing the Corporation may also manage other users' access and permissions related to giving on behalf of a Corporations

### Gifter Application

The Gifter application (client code 74a of the user computing device 14a) is available on both the Web and Mobile Platforms. The same Web application used by NPOs is also used by Gifters on the Web. All user accounts are able to be Gifters using their personal account. This same account may have access to manage an NPO or a corporation. It is immediately obvious on the dashboard and header which entity they are representing. The mobile apps for gifters contain all the same functionality available to gifters on the web application.

Thus, in this embodiment, Gifters use same web app as NPOs. However, Gifters can optionally use an app built exclusively for gifters. The Gifter mobile application has exact same features as its web counterpart.

### Gifter Searching for NPOs

Gifter searching can be facilitated by ElasticSearch or a similar service. Gifters are able to search for NPOs or Needs, based on a variety of data points, such as name, location, price, affinities, trending, recommended, or even room name.

### Gifter Donating

Gifters are able to donate one or more items at a time from any number of Rooms, with the funds automatically being sent to the correct NPO. Each transaction has its own privacy setting, which allows the user to remain anonymous for a particular transaction. Their identity is hidden from the Item's public donation history and the transaction does not appear on the Gifter's public profile. The Gifter may also optionally hide their identity from the NPO, as well.

The gifter is required to donate the partial or full amount, plus the transaction fee which is a percentage of the total amount they're gifting. In some cases the server 12 may have a minimum for partial gifting, such as $1 or $5 increments.

### Gifter Wishlist

Gifters have wish lists to keep track of donations they are interested in. Wish lists can also be shared publicly with a URL for their friends or family to donate goods from. The use case is the situation in which the gifter communicates to friends or family, “Instead of buying me a gift, buy a gift for one of the NPOs in need.” Gifters can create, manage and name multiple wish lists.

Specifically, the servers 12 allows Gifters are able to create wish lists of items to donate and stores the data in the memory 54. The server 12 allows the Gifters to share wish lists via public URL maintained by or at least accessible by the server 12.

### Gifter Dashboard

Gifters' dashboards contain a variety of items. A social activity section contains a timeline of events, followed organizations, and gifting friends. There is no Direct Messaging or commenting in order to keep the platform free of hate or other possible abuses. The dashboard also contains the gifter's contribution history, displaying all donations, recurring donations, giving statement and tax receipts. The dashboard also contains the user's account settings for Notifications (real-time and/or summary), payment methods and the ability to cancel their account.

### Gifter Profile

Each of the Gifters' Profiles display the gifter's following information: bio, photo, public donation history and their impact. Gifter Profiles also display the users Wishlist's they have marked as public.

The system 10 is built around an item-based giving model. This takes place within the NPO online Room. Rooms are used so that NPO's place on display in their room's “windows” their most pressing needs for everyone to see. The room can be filled with tangible items, as a motorized scooter, a warm winter coat, or intangible but designated items such as sending a child to church camp or scholarships. The Room also provides an undesignated cash fund similar to how many donations are received/requested currently. The wide range of possible items registered for allows everyone to make a difference whether it's the little kid trying to make a difference with the profits from his lemonade stand or a big corporation sitting down to allocate their large yearly charitable contributions.

Research indicates that when people can easily envision the difference their gift has made, they report higher levels of happiness. In contrast, when it's difficult for donors to see the difference they were making the emotional return on investment is completely eliminated. This suggests that giving can actually increase an individual's happiness. However, it matters how one gives. Giving ideally is done in a way where people can see the exact impact they are making. The technical solution of the system 10 brings this advantage to life.

As individuals are able to navigate through online Rooms they are able to select exactly how they wish to make an impact, be able to clearly visualize the lives they are transforming and in turn have their own lives (happiness) transformed.

Another important aspect of the system 10 is the alignment technology. This piece connects the Not-for-Profit specific registered needs with Gifter's all over the nation. The system 10 provides a guided user sign up experience. Gifters (Individuals, Small Businesses, Corporations, and Foundations) are prompted to indicate their affinities, such as passions and interests (sports, health, veterans, nature, education, religion, cooking, etc.). Then, the system's alignment technology connects registered needs of the NPOs to the gifter based on their indicated affinities. This creates reach NPOs are unable to do on their own, and a technical advance in providing salient data related to matching donors and organizations via a user interface.

The system 10 allows the ability to follow friends, family and NPOs. The system 10 notifies gifters when anyone the gifter is following is making a difference, and also when any NPO Room the gifter are following is being supported. Research has found that when people's actions and decisions were more observable, they were more likely to perform good acts. Whether we are aware of it or not, increased observability is a big part of why people perform good acts in the first place.

The system's provision of user interface displays conveniently indicate when anyone the gifter is following has made a difference and for the gifter's followers to see the gifter's good deeds. This increased observability and social engagement leads to more good.

Another innovation in the platform is the opportunity to sponsor a room for a larger donation. Rooms in one embodiment have an annual cost. The system 10 requires a room being open so that the NPO to clearly display their most pressing needs. Without a Room filled with critical needs, gifters cannot be aligned and inspired to make a difference. The sponsorship functionality gives “gifters” (individuals, families, small businesses, large corporations and foundations) the opportunity to put their name on a room and, cover the cost of the room on behalf of the NPO for a year. The server 12 causes the Sponsors of the Room to have their name appear at the top of the NPO Room as well as in every confirmation email sent to a gifter.

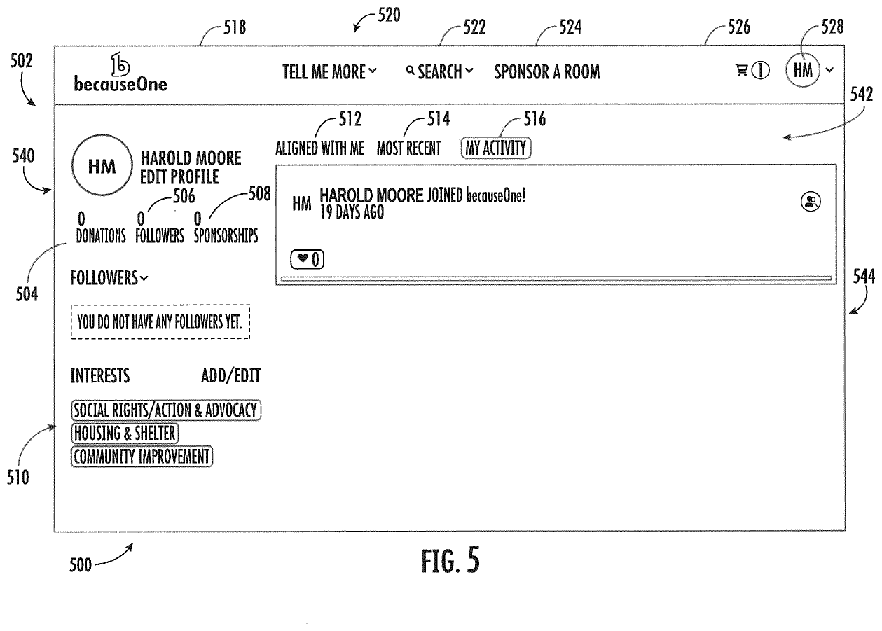

Another technical advance of at least some embodiments is the user interface that allows for the logical and useful navigability of a user to organizations (i.e. NPO's) that align with the user's interests. FIGS. 5 to 12 show an embodiment of the system 10 that can perform the operations of FIG. 2, but provides in further detail exemplary interactive displays and operations as described below. The server 12 generates the user interface 500 based on a series of web pages with interactive screens that are used to navigate to other pages and/or enter data, and/or conduct financial transactions. The example of FIGS. 5 to 12 only includes a single Room ID associated with each Organization ID, but otherwise uses the general structure described above in connection with FIGS. 1 to 4.

FIG. 5 shows a landing page screen 502 of a first page or landing page of registered gifter in a user interface 500 another embodiment of the system 10. The server 12 generates the display 502 based at least in part on the User ID of the logged-in user currently in the session (“Current User ID”), and by reference to the user data object 114 (and gifter data object 106) associated with the Current User ID. The landing page display 502 includes a dashboard, showing donations count 504, a followers count 506, and a sponsorships count 508, a set of affinity links 510, an aligned folder tab 512, a recent folder tab 514, and an activity folder tab 516. The landing page 502 also includes a top banner 518 that includes a general information button (i.e. user-selectable text) 520, a search button 522, and a sponsor action button 524, a shopping cart button 526, and a user info circular button 528. It will be appreciated that the display 502 and other displays discussed herein may be scrolled vertically if information does not readily fit on the visible portion of the display, as is well-known in the art.

Before discussing the landing page screen/display 502, the main browse display will be discussed. FIGS. 6, 7 and 8 show an examples of the interactive main browse display 602 of the user interface 500. As will be discussed below the server 12 causes display of the main browse display 602 responsive to various selections on the landing page 502, and in many cases based on information on either or both of the user data object 114 associated with the Current User ID and the gifter data object 106 associated with the Current User ID.

Referring to FIG. 6, the browse display 602 includes the top banner 518, a type selection bar 604, a search text input block 606, a filter button 608, a results number 610, a results control element 612, and a results pane 614. In this example, the results pane 614 includes a plurality of Item Cards 640. However, as will be discussed below, the results pane 614 can alternatively show other types of cards.

The top banner 518 is described further below in connection with FIG. 5. The top banner 518 is the same in the landing display 502 and the browse display 602, and may suitably be in most or other displays of the user interface 502. As will be discussed further below, the top banner 518 allows for functions independent of the browse display.

The type selection bar 604 both displays, and allows for selection of, the type of cards that are displayed in the results pane 614. The type selection bar 604 includes a Room button 604a, a Needs button 604b, and a Gifter button 604c. Upon user selection of one of the buttons 604a, 604b, 606c, the server 12 will perform a search based on any filters (discussed further below) of the type selected, applying any filters as discussed below. The server 12 will further change the appearance of the selected one of the buttons 604a, 604b, and 604c to show what is being displayed in the results pane 614. The server 12 in many cases will predetermine the initial type selection each time the browse display 602 is navigated to, as will be discussed below.

The current type selection in FIG. 6 is the Needs button 604b, as indicated by the different or highlighted appears of the Needs button 604b compared to the other two buttons 604a, 604c. The results pane 604 shows a plurality of item cards 640, which can be the subject of filters and/or text searching. Each item card 640 corresponds to an item data object 104 stored in the database 54b. The server 12 generates item cards 640 to include an image (e.g. photo or visual graphic) based on the Photo URL of the item data object 104, a title based on the Name in the item data object 104, a price based on the Price of the item data object 104, a text description which may suitably be part of or at least associated with the item data object 104, and a link to conduct a transaction to donate the item, or at least to donate an amount corresponding to the price of the item.

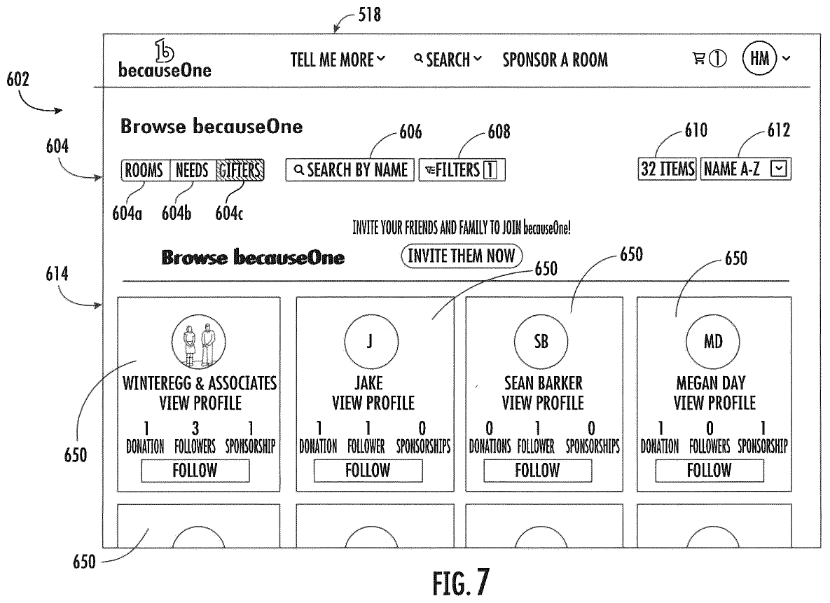

Referring to FIG. 7, the browse display 602 in this example has gifter cards 650, and the Gifter button 604c is shown as highlighted. Each gifter card 650 corresponds to a gifter data object 106 (and hence a user object 114) stored in the memory 54 (database 54b). The server 12 generates gifter cards 650 to include an image (e.g. photo or visual graphic) based on a stored photo that the user may enter (which can be associated with the gifter data object 106 or the user data object 114 corresponding to the gifter). The server 12 further causes the gifter card to include a name based on the Name in the gifter data object 104, a donation number indicator, a followers indicator, and a sponsorship indicator. All of the data may be obtained from the gifter data object 104, although the platform may alternatively generate the donation number indicator by searching transaction data objects 112 that match the User Id of the gifter in the card 650, and counting the matches. Each gifter card 650 also includes a follow button. Responsive to a selection of the follow button in the gifter card 650, the server 12 updates the Gifters Followed data of gifter data object 106 associated with the Current User ID to include the User ID of the person associated with the gifter card 650.

Referring to FIG. 8 an excerpt of another example of the browse display 602 is shown, provided responsive to selection of the Rooms button 604a. The browse display 602 of FIG. 8 shows room cards 660 in the results pane 614, and the rooms button 604a highlighted. Each room card 660 corresponds to a room data object 102 (which is then associated or is part of an organization data object) stored in the memory 54 (database 54b). The server 12 generates room cards 660 to include an image (e.g. photo or visual graphic) based on a stored photo that the Owner User user may enter, or a photo URL (which can be associated with the room data object 102 or the organization data object 108 corresponding to the room). The server 12 further causes the room card 660 to include a name based on the Name in the room data object 102, a number of donations and the number of needs, preferably depicted as a thermometer graph, affinities of the room and/or organization, and text description of the organization. The server 12 may generate the information based on data may be obtained from the room data object 102, the organization data object 108, the item data objects 104 that have the corresponding Room Id as part of their data, and/or transaction data objects 112 that have the corresponding Room Id.

The server 12 may also display an indicator as to whether a sponsor is needed in the card 660. In one embodiment the server 12 only displays the sponsor needed button in the room card 660 if a sponsor is needed for the room, either currently, or for the following year. As discussed above, in this embodiment, the server 12 can search the sponsor data object 110, which is separately maintained from the room data objects 102, to determine whether a particular room needs a sponsor either currently, or in the next year. If the user selects a sponsor needed button, then the server 12 navigates to a new display that allows for a sponsorship transaction to occur. In a sponsorship transaction, the gifter pays a fee to become the sponsor of the room.

If the server 12 determines that the room of a card 660 has an existing sponsor, then information identifying to the sponsor is displayed in the room card 660 or otherwise to acknowledge their sponsorship. The server 12 updates both the room data object 102 and/or the sponsor data object 110 to reflect any new sponsorship. The server 12 removes the sponsorship from the room data object and the separate list after a predetermined time, such as a calendar year. In this manner, a new sponsorship and new donation may occur.

Referring again to FIG. 6 and general discussion of the browse display 602, the search text input box 606 allows for searching by name (e.g. Item ID, Gifter ID, or Room/Organization ID). In this example, because the type selection is Needs and the needs button 604b is highlighted, the server 12 would search for text entered in the search text input box 606 in all of the Item IDs of all item data objects 104 stored in the database and/or memory associated with the server 12, subject of course to any filters.

The filter button 608 allows the user to add filters to the filter the items displayed in the results pane 614. The filters available vary based on whether Rooms, Needs, or Gifters is selected from buttons 604a, 604b, and 604c.

For Rooms (button 604a), the selectable filters include location information (e.g. zip code), Affinities, and whether the Organization needs a sponsor. If the zip code filter (or other location information) is selected, the server 12 provides a box on the display in which a zip code number (or other information) may be entered. In this embodiment, once the zip code information is entered as a filter, the server 12 searches the population of Organization data objects 108 for those that contain an address that have a zip code that is within a predetermined distance of the zip code entered in the filter, or which is otherwise associated geographically or in some other way with the zip code entered in the filter.

In this embodiment, the server 12 displays Affinities filter options automatically as the list of the predetermined set of affinities (discussed further above), each with a selection box or button. For each Affinity box selected, the server 12 filters the list of Organizations to display only those that have at least one of the selected Affinities in their Organization data object 108. The server 12 may suitably order the display of the Organizations by the number of Affinities that match the search criteria. Multiple filters can be applied to any search.

It is noted that in this embodiment each organization has a single room associated with it. Thus, the results of the search for Organizations in this embodiment comprise a list of the Room Ids associated with the Organizations that fit the searched criteria. In all cases, when the Organization/Rooms are displayed (filtered or unfiltered), the server 12 displays a set of room cards 660 in the results pane 614. After filters are applied and the server 12 generates of list of Room IDs that fit the filter criteria, the server 12 generates room cards 660 corresponding to the list and causes them to be displayed in the results pane 614. The user may then select to “follow” the room and/or organization, or sponsor the room, or enter and determine the item needs of the room by selecting the appropriate button on the room card 660.

Referring again to the filter criteria-if the “Rooms needing a Sponsor” filter is selected, then the server 12 searches the rooms that need a sponsor currently, or if after a certain calendar date, for the next calendar year. In one embodiment, the server 12 maintains in the sponsor data object 110 each Room ID, its User ID of the Current sponsor, and the User ID of the following year sponsor. (See FIG. 3). In this manner, the server 12 need not need not search all of the Organization data objects 108 for those without a sponsor, but rather just the sponsor data object 110. The server 12 displays room cards 660 for the unsponsored rooms in the manner discussed above. It will be appreciated that if multiple filters are selected, then the server 12 displays only the room cards 660 that satisfy the multiple filtering criteria.

Referring again to the type selection bar 604, if the “Gifters” button 604c is selected, then the server 12 initially displays all gifters as gifter cards 660 as shown in FIG. 7. The server 12 also makes filtering available on the basis of Affinities and geographical criteria in the same manner as discussed above in connection with Organization searches. The server 12 then filters in a manner to analogous to that discussed above to display gifter cards 650 for Gifter Ids whose gifter data object 106 lists the corresponding affinity, and/or matches the geographical criteria selected by the user.

Referring again to the type selection bar 604, if the “Needs” button 604b is selected, then the server 12 initially displays all items needed as item cards 640 as shown in FIG. 6. The server 12 also makes filtering on the basis of Affinities and geographical criteria, and displays item cards 640 for Item IDs having the corresponding Affinity in their item data object 104, and/or is associated a Room Id with an Organization having a zip code matching the geographical search criteria.

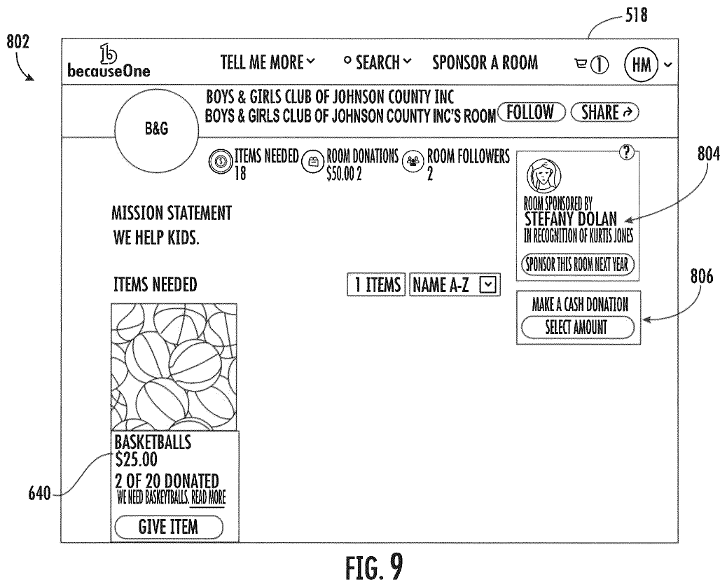

FIG. 9 shows an exemplary room display 802 of the interactive interface 500 that the server 12 generates in response to selection of a room from a room card 660. The room display 802 identifies the Organization associated with the room being displayed, and includes a display of the needs of the organization in the form of corresponding item cards 640′ (which can vary from the format shown in the display 602). The item cards 640′ include an interactive “give” button that will cause the server 12 to move the user to the transaction function in which the money may be donated for the particular Need identified in the item card 640′.

The room display 802 further includes a sponsor identification pane 804. The sponsor identification pane identifies the current sponsor using information from the sponsor data object 110 and the user data object 114. The sponsor identification pane 804 will also indicate whether a current year sponsor, or following year sponsor, is needed.

In addition, the room display 802 includes an interactive graphic element 806 for donating directly to the Organization associated with the Room being displayed. The room display 802 also includes statistics, such as total items needed, total donations (within a predetermined period), and number of followers of the Organization.

Referring again to the landing display 502 of FIG. 5, the top banner 518 is disposed across the top of the display 502, as it preferably is on most or all other displays as well. If the general information button 520 is selected by the user (by mouse click or comparable selection mode), the server 12 provides a drop-down menu of general information choices, from which a user may select to navigate to a corresponding page. If an item from the drop-down menu is selected, then the server 12 navigates the client 14a to the corresponding page. For example, the menu of general information choices may include “About Us” and “FAQ” selectable links that, if selected, cause the user to navigate to corresponding pages having information, respectively, about the organization hosting the system 10, and frequently asked questions and corresponding answers regarding the system 10.

If the Search button 522 of the top banner 518 is selected, the server 12 generates a drop-down menu of selectable items to search. For example, the selectable items in this embodiment include Gifters, Organizations, and Items Needed. If any item is elected, then the server 12 presents a search page for that category. The search page is in this embodiment the browse display 602 of FIGS. 6, 7 and/or 8.

If Organizations is chosen, then the server 12 displays the display 602 of FIG. 8 with the rooms button 604a highlighted and room cards 660 in the results pane 614. If “Gifters” is selected, then the server 12 displays the display 602 of FIG. 7 with the gifters button 604c highlighted and gifter cards 650 in the results pane 614. If “Items Needed” is selected, then the server 12 displays the display 602 of FIG. 6 with the needs button 604b highlighted and gifter cards 640 in the results pane 614. The user may then proceed operations from the browse display 602 as discussed above.

It will be appreciated that certain portions of the user interface 500, for example, the browse display 602, may be accessed by unregistered users via a suitable computing device having the general structure of the client computing device 14a, 14b, etc. However, other functionality may not be available.

Referring again generally to the top banner 518 of FIG. 5, the sponsor button 524 is another a selectable text element on the display 502, similar to the general information button 520 and the search button 522. Responsive to user selection of the sponsor button 524, the server 12 displays room cards 660 for room data objects 102 wherein no sponsor exists either currently, or after a predetermined calendar date, for the following year. In this embodiment, the server 12 performs the same operation as if the user had selected the Organization search from the drop-down menu provided by selecting the search button 522, and had selected to filter by rooms needing a sponsor, as discussed above.

The shopping cart button 526 includes a selectable shopping cart icon. The platform determines how many gifts have been selected for donation which are associated with the Current User Id, but for which payment has not been transacted, and places this number next to the shopping cart button 526. Responsive to selecting the shopping cart button 526, the server 12 navigates the client 14a to a check out/payment transaction page.

The user button 528 includes the user's initials within a circle and is user selectable. To this end, the platform 528 obtains the name from the user data object 114 associated with the Current User Id. Responsive to selection of the user button 528, the server 12 provides a drop-down menu that includes selectable choices to log off the system 10 and/or server 12, and to edit account settings. Responsive to selection of the “edit account settings”, the server 12 causes display of a page, not shown, where the user may edit various account settings, such as payment methods, password, notification settings, affinities, and public profile (such as a photo) associated with the Current User ID.

Referring again to FIG. 5, the display 508 includes a user data pane 540, an upper tab pane 542, and a main news pane 544. In this embodiment, the user data pane 540 is a column on the left below top banner 518, and the upper tab panel 542 is a horizontal pane immediately below the top banner 518 and to the right of the user data pane 540. The main news pane 544 is immediately below the upper tab panel 542 and to the right of the user data pane 540.

The user data pane 540 includes text identifying the user's name, and also include the donations count 504, a followers count 506, and a sponsorships count 508, a set of affinity links 510. The server 12 generates the values for the counts 504, 506 and 508 based on the information in the Gifter data object 106. The Affinity links 510 include a generated selectable button with text identifying each of the Affinities associated with the Current User ID via the Gifter data object 106. Selection of an Affinity link 510 leads to a page providing further information regarding the Affinity.

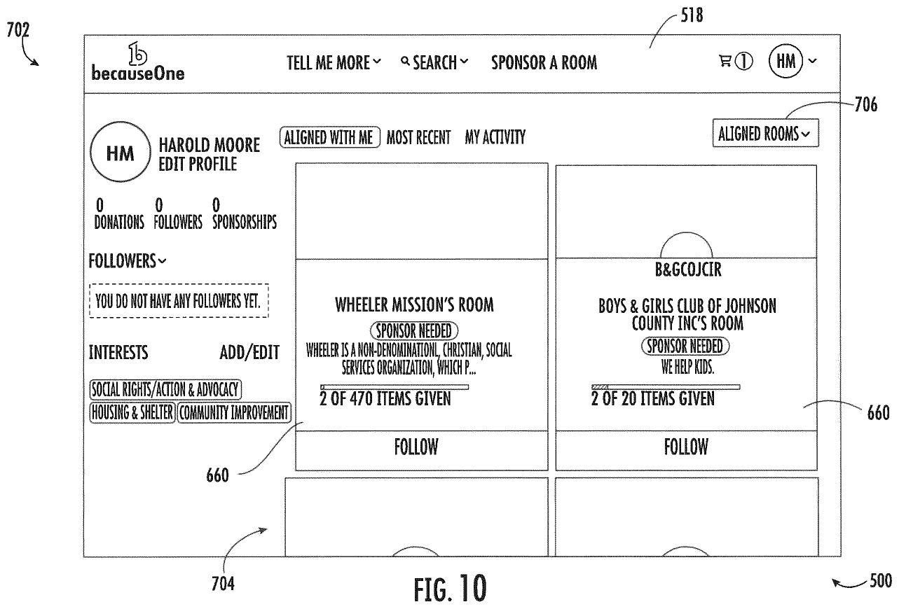

If the user selects the aligned folder tab 512, then the server 12 causes the client 14 to generate an aligned display 702 as shown in FIG. 10, The aligned display 702 is similar to the landing display 502 except that the main area 704 includes cards, and there is a selection box 706. The selection box 706 allows the user to select either aligned rooms, or aligned needs/items. FIG. 10 shows “aligned rooms” selected. In response to such a selection, the server 12 identifies the Organization IDs that have at least one Affinity in their organization data object 108 that matches or corresponds to the interest in the gifter data object 106 of the Current User ID.

The server 12 may use weighting to prioritize the order of the presentation of the list on the display. The weighting may be based on the number of matching affinities with the Organization ID with the matching room, geographical proximity information based on the zip codes associated with the Organization ID address and Current User ID address, and preferably a combination of both. The weighting may also take into account whether the matching affinity is a designated “primary” and “secondary” affinity associated with the Organization ID address or Current User ID address. The server 12 then causes display of room cards 660 based on the list in a manner corresponding to prioritization if a prioritized list is used.

Similarly, if the selection box 706 is used to select aligned needs, the server 12 identifies the Item IDs that have at least one Affinity in their item data object 104 that matches or corresponds to the interest in the gifter data object 106 of the Current User ID. The platform may use weighting and prioritization as discussed above. Prioritization may also take into account other factors, such as whether the organization and the item have affinities that match those of the current user.

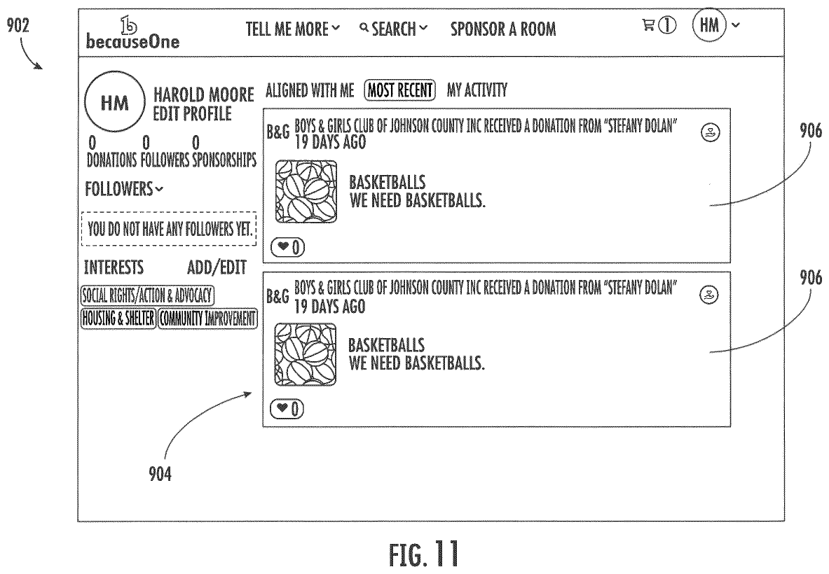

Referring to FIG. 5, if the Most Recent button 514 is selected the server 12 generates the interactive display 902, an example of which is shown in FIG. 11. The interactive display 902 is the same as the landing display 502, except that the server 12 causes display in the main pane 904 of cards 906 providing information and images on recent donations or sponsorships by gifters followed identified in the gifter data object 106 of the Current User ID, and/or rooms or organizations followed identified in the gifter data object 106 of the Current User ID. The ability to obtain updates regarding gifters and rooms followed helps facilitate interest in giving and participation. The server 12 further generates such information based on the Created At data for the transaction data objects, for example, to identify the most recent transactions involving the followed gifters and/or followed rooms/organizations identified in the gifter data object of the Current User ID.

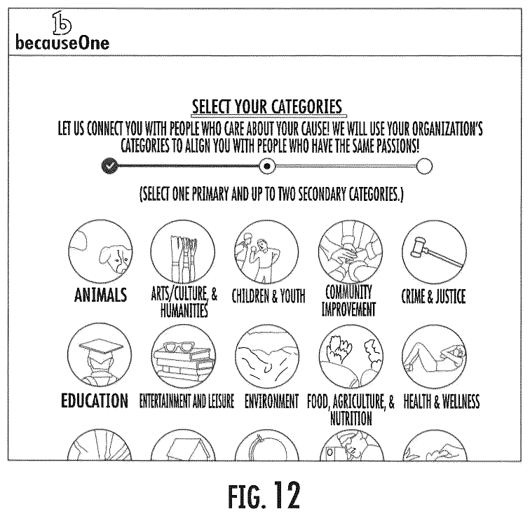

FIGS. 12 shows a display generated by the server in connection with obtaining the second affinity information for organizations, as per step 204 of FIG. 2. A similar display is used for selection of first affinity information for donor users and third affinity information for needs or items, per steps 202 and 206 of FIG. 2. As shown in FIG. 12 the server causes a selectable graphic for each affinity from the predetermined set of affinities to be displayed, although the user may need to scroll the display to see them all. Each selectable graphic is a selectable button with text identification below the button, and a representative photo or graphic in the button. When the user selects a button, it becomes an affinity associated with that user or item, depending on whether it is selected during step 202, 204 or 206 of FIG. 2.

The server 12 also facilitates various actions of Organization Users via the client computing devices 14. As discussed above in connection with step 206 of FIG. 2, the server 12 provides an interface to allow an Organization user to enter new Needs (or items) and enter the data for the corresponding new item data block 104, which is then stored by the server 12.

As discussed above, the “Created At” field of the various data blocks 102, 104, 106, 110 and 112 to enable updates and news feeds, such as those that would be used to populate the display 902 of FIG. 9. In one embodiment, the server 12 further generates periodic email updates to donor users and even organization users, which contain information regarding recent activity.

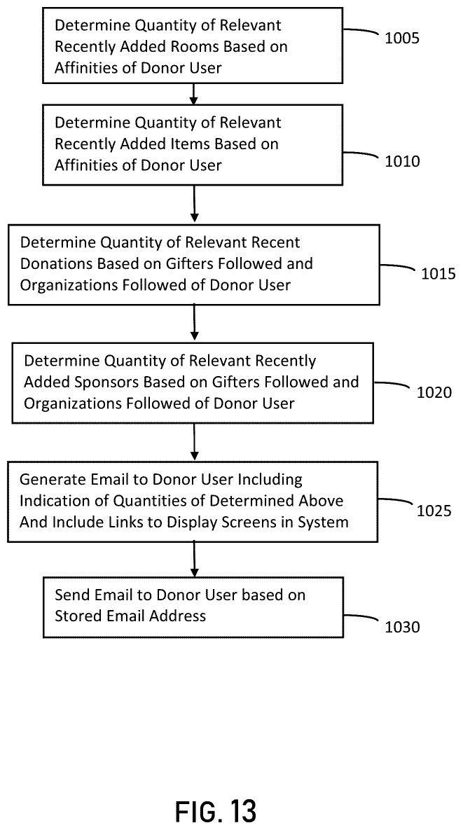

To this end, FIG. 13 shows an exemplary flow diagram of the operations of the server 12 in generating an update email to donor user. In general, the server 12 may generate updates on a periodic basis, such as daily, every 48 hours, or weekly. The generated email contains statistics (e.g. counts) regarding select new needs (new item data blocks 104), new room data blocks 102, new donations (new transaction data blocks 112 and new sponsor data blocks 110. The server 12 generates a different email customized for each donor user based at least in part on the Organizations Followed, Gifters Followed, and Affinities of the gifter data block 106 for the donor user.

In step 1005, the server 12 determines the quantity of recently added room data blocks 102 that have at least one affinitiy matching those of the user's gifter data block 106. The server 12 determines whether a particular room data block 102 was added recently (and should be added to the quantity) based on the “Created At” field of the data block 110. To this end, the server 12 may maintain a separate table of recent data blocks 102, 104, 110 and 112 having a “Created At” value that is later than the last email update.

In step 1010, the server 12 determines the quantity of recently added item data blocks 104 (i.e. new needs entered in the system 10 by an organization user) that have at least one affinitiy matching those of the user's gifter data block 106. The server 12 determines whether each item data block 104 was added recently (and should be added to the quantity) in the same manner as discussed above in connection with step 1005.

In step 1015, the server 12 determines the quantity of recent donations relevant to the current donor user to be emailed. To this end, the server 12 determines the quantity of recently added transaction data blocks 112 that have a User ID that corresponds to one of the Gifters Followed of the user's gifter data block 106, and/or that have a Room ID that corresponds to one of the Organizations Followed of the user's gifter data block 106. The server 12 determines whether the transaction data block 112 was added recently (and should be added to the quantity) in the same manner as discussed above in connection with step 1005.

In step 1020, the server 12 determines the quantity of recent sponsorships relevant to the current donor user to be emailed. To this end, the server 12 determines the quantity of recently added sponsor data blocks 110 that have a User ID that corresponds to one of the Gifters Followed of the user's gifter data block 106, and/or that have a Room ID that corresponds to one of the Organizations Followed of the user's gifter data block 106. The server 12 determines whether the sponsor data block 110 was added recently (and should be added to the quantity) in the same manner as discussed above in connection with step 1005.

In step 1025, the server 12 generates an email that conveys each of the quantities determined in steps 1005, 1010, 1015 and 1020 with corresponding text labels, and further contains user selectable links to the one or more displays of the user interface 500. In step 1030, the server 12 causes the email to be sent to the email address in the user data block 114 of the user.

It will be appreciated that instead of obtaining affinities directly from donor users, digital marketing systems may be used to obtain at least some of the affinities of donor users. The server 12 may thus use profile information on donor users available from outside data providers to develop the donor user affinities from the predetermined list of affinities. However, the embodiments described above, wherein the donor user provides the affinity information directly within the system 10, provides a more focused matching with organizations having needs, and provides a greater level of transparency and control to the donor user. This, in turn, creates a level of trust and enthusiasm that can enhance the giving.

Other features and advantages are shown in the drawings themselves, and may be derived through the operation of the system 10 as discussed above, the data objects shown in FIG. 2 (and/or variants thereof), and the interact elements on the screens or displays.

1. A method for providing a user interface to information regarding donations to organizations, comprising:
a) obtaining in at least one server computer first affinity information selected by a first donor user;
b) obtaining in the at least one server computer second affinity information relating to each of a plurality of organizations, wherein the second affinity information for each organization corresponds to an attribute of the organization;
c) determining in a computer processor of the at least one server computer a subset of the plurality of organizations based on a correlation of the first affinity information and the second affinity information; and
d) providing graphic card information relating to the subset of organizations to a first client computing device, wherein the graphic card information is configured to be displayed on a user interface of the first client computing device such that a graphic card is displayed on the first client computing device identifying and corresponding to each of the subset of the plurality of organizations.

2. The method of claim 1, wherein the graphic card information is configured such that each graphic card includes a first link selectable by the user interface, the first link associated with the organization identified in the graphic card, and the method further comprising:
responsive at least in part to selection of the first link, providing on the user interface a transaction operation for transferring funds to the organization identified in the graphic card.

3. The method of claim 2, further comprising, responsive to receiving a selected first link of a first organization, providing further graphic card information, wherein the further graphic card information is configured to be displayed on a user interface of the client computing device such that a further graphic card is displayed identifying each of the subset of items corresponding to donation needs of the organization, the graphic cards identifying a cost per item, a quantity of items needed, and a further link to a transaction operation.

4. The method of claim 3, wherein step b) comprises:
causing a display on a second client computing device a predetermined set of affinities;
receiving at the server from the second client computer information identifying at least one of the predetermined set of affinities, wherein the identified at least one of the predetermined set of affinities comprises the second affinity information relating to the organization.

5. The method of claim 4, wherein the server limits the identified at least one of the predetermined set of affinities to a predetermined number, wherein the predetermined number is less than a quantity of the affinities in the predetermined set of affinities.

6. The method of claim 1, further comprising:
e) obtaining in the at least one server computer third affinity information relating to each of a plurality of items, the items corresponding to donation needs of the plurality of organizations, wherein the third affinity information for each item corresponds to an attribute of the item;
f) determining in the computer processor of the at least one server computer a subset of the plurality of items based on a correlation of the first affinity information and the third affinity information;
g) providing further graphic card information relating to the subset of items to the first client computing device, wherein the further graphic card information is configured to be displayed on the user interface of the client computing device such that a further graphic card is displayed identifying each of the subset of the plurality of items, the graphic cards identifying a cost per item, a quantity of items needed, and a further link to a transaction operation.

7. The method of claim 6, further comprising using the server to provide a first graphical user interface display to the first client computing device, the first graphical user interface display including first and second selectable buttons, and wherein:
responsive to selection of the first button, performing steps c) and d); and
responsive to selection of the second button, performing steps f) and g).

8. The method of claim 6, further wherein step a) further comprise obtaining in a at least one server computer first affinity information selected by each of a plurality of further donor users, the method further comprising:
h) determining in the computer processor of the at least one server computer a subset of the plurality of further donor users based on a correlation of the first affinity information of the first donor user and the first affinity information of the plurality of other donor users;
i) providing additional graphic card information relating to the subset of the plurality of further donor users to the first client computing device, wherein the additional graphic card information is configured to be displayed on the user interface of the first client computing device such that a further graphic card is displayed identifying each of the subset of the plurality of further donor users, the graphic cards identifying corresponding donor identification information and donation statistics corresponding to the donor identification information.

9. The method of claim 8, further comprising using the server to provide a first graphical user interface display to the first client computing device, the first graphical user interface display including first, second and third selectable buttons, and wherein:
responsive to selection of the first button, performing steps c) and d);
responsive to selection of the second button, performing steps e) and f); and
responsive to selection of the third button, performing steps h) and i).

10. A method for providing a user interface to information regarding donations to organizations, comprising:
a) providing to at least one server computer first affinity information selected by a first donor user via a computing device user interface;
b) obtaining in a first client computing device from the at least one server computer graphic card information relating to the subset of organizations, wherein the subset of organizations have been associated with a second set of affinities in a memory, and wherein the second set of affinities for each of the subset of organizations correspond at least in part to the first set of affinities;
c) displaying on a user interface of the first client computing device, based on the received graphic card information, a separate graphic card is displayed on the first client computing device identifying each of the subset of the plurality of organizations.
